(19) United States
(12) Patent Application Publication
(10) Pub. No.: US 2018/0141518 A1
(43) Pub. Date: May 24, 2018

(54) Wireless Thief-Hatch Monitoring System

(71) Applicant: Signal Fire Telemetry, Hudson, MA (US)

(72) Inventors: Mark Iverson, Kenosha, WI (US); Scott Keller, Still River, MA (US); Robert A. Strauss, Dublin, NH (US)

(73) Assignee: Signal Fire Telemetry, Hudson, MA (US)

(21) Appl. No.: 15/818,717

(22) Filed: Nov. 20, 2017

Related U.S. Application Data
(60) Provisional application No. 62/425,594, filed on Nov. 22, 2016.

(51) Int. Cl. B60R 25/30; B60R 25/31; B60R 1/08; H04N 7/18

(52) U.S. Cl. CPC B60R 25/305; H04N 7/181; B60R 1/08; B60R 25/31

(57) ABSTRACT

A thief hatch state monitoring system includes a thief hatch sensor that detects a change in angular position of a thief hatch and generates sensor data at an output in response to the detected change. A processor having an electrical input is electrically connected to the output of the thief hatch state sensor. The processor determines when the angular position of the thief hatch changes by more than a predetermined amount from the sensor data and then generates a transmit signal indicating a state of the thief hatch. A network interface is electrically connected to an output of the processor. The network interface generates a signal that indicates the state of the thief hatch. A communication gateway includes a receiver that receives the signal indicating the state of the thief hatch. The communication gateway is electrically connected to a network that provides an end-user remote access to the state of the thief hatch.

### CROSS REFERENCE TO RELATED APPLICATION

The present application is a non-provisional application of U.S. Provisional Patent Application No. 62/425,594 entitled “Wireless Thief-Hatch Monitoring System” filed on Nov. 22, 2016. The entire contents of U.S. Provisional Patent Application No. 62/425,594 are herein incorporated by reference.

The section headings used herein are for organizational purposes only and should not to be construed as limiting the subject matter described in the present application in any way.

### INTRODUCTION

Industrial tanks and storage systems are used in a variety of industrial applications including oil and gas, water and waste water, industrial chemicals, paper, agriculture, cooling and power, and transportation. For example, oil recovery, processing and distribution oil tanks store petroleum products at various phases of production. Such oil tanks may be distributed across oil fields and oil storage fields located around the world.

It is highly desirable to monitor industrial tanks in order to enable reliable and efficient petroleum processing operations. In many industrial tank installations, sensors are associated with each industrial tank and are connected to a gateway that connects to the Internet as well as to back-end servers that allow users to interface to the data from the sensor. In some installations, these sensors can be remotely configured. Such industrial tank monitoring and control systems provide remote monitoring and control of a variety of industrial processing functions.

Most industrial tanks have what is known in the industry as a thief hatch, which is a closable aperture in the tank wall that is opened and closed during operations. Typical thief hatches have a number of different purposes, which include allowing for easy sampling of tank content, determining the product level in the tank, and protecting the tank from over and under pressure conditions.

### BRIEF DESCRIPTION OF THE DRAWINGS

The present teaching, in accordance with preferred and exemplary embodiments, together with further advantages thereof, is more particularly described in the following detailed description, taken in conjunction with the accompanying drawings. The skilled person in the art will understand that the drawings, described below, are for illustration purposes only. The drawings are not necessarily to scale, emphasis instead generally being placed upon illustrating principles of the teaching. The drawings are not intended to limit the scope of the Applicant's teaching in any way.

FIG. 1 illustrates a sketch of an exemplary thief hatch on an oil tank situated in an oil field.

FIG. 2 illustrates an embodiment of a sensor device for a thief hatch monitoring system according to the present teaching.

FIG. 3 illustrates an embodiment of a remote thief hatch monitoring system connected with a wireless network interface of the present teaching.

FIG. 4 illustrates an embodiment of a remote thief hatch monitoring system connected with a wired network interface of the present teaching.

### DESCRIPTION OF VARIOUS EMBODIMENTS

The present teaching will now be described in more detail with reference to exemplary embodiments thereof as shown in the accompanying drawings. While the present teachings are described in conjunction with various embodiments and examples, it is not intended that the present teachings be limited to such embodiments. On the contrary, the present teachings encompass various alternatives, modifications and equivalents, as will be appreciated by those of skill in the art. Those of ordinary skill in the art having access to the teaching herein will recognize additional implementations, modifications, and embodiments, as well as other fields of use, which are within the scope of the present disclosure as described herein.

Reference in the specification to “one embodiment” or “an embodiment” means that a particular feature, structure, or characteristic described in connection with the embodiment is included in at least one embodiment of the teaching. The appearances of the phrase “in one embodiment” in various places in the specification are not necessarily all referring to the same embodiment.

It should be understood that the individual steps of the methods of the present teachings can be performed in any order and/or simultaneously as long as the teaching remains operable. Furthermore, it should be understood that the apparatus and methods of the present teachings can include any number or all of the described embodiments as long as the teaching remains operable.

Currently, thief hatches for industrial tanks are widely used. This is particularly true for oil tanks in oil fields. For example, nearly all oil tanks that are located in oil fields have a thief hatch. New sensor technology that improves thief hatch reliability and operations is highly desirable. One aspect of the present teaching is the recognition that thief hatches would benefit from simple sensor devices that monitor the state of the thief hatch and that ensure proper operation and/or configuration of the thief hatch. While much of the description of the present teaching relates to thief hatch monitoring of oil tanks, it will be clear to those skilled in the art that thief hatch monitoring of the present teaching can be used for thief hatches attached to any of a variety of industrial tanks.

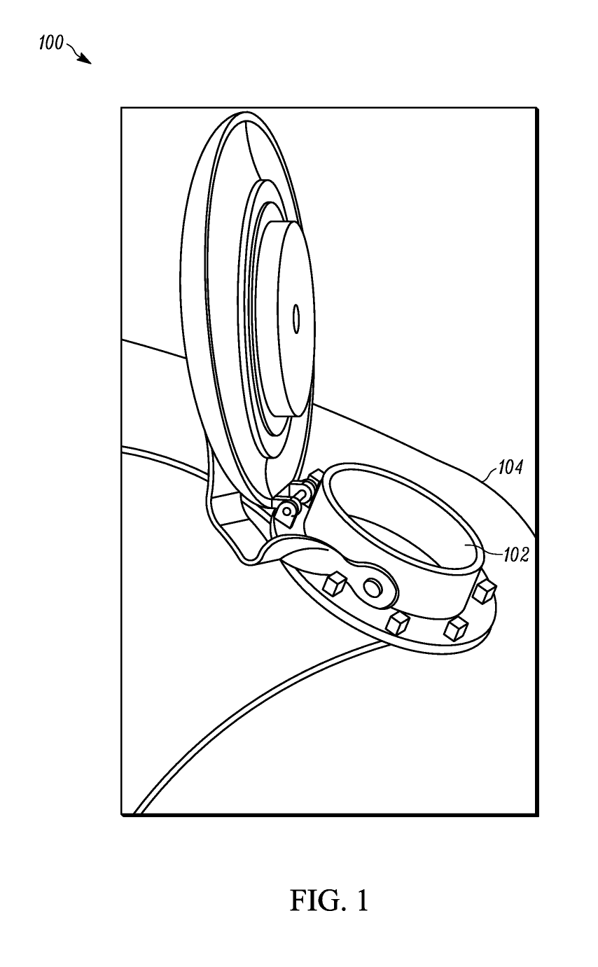

FIG. 1 illustrates a sketch 100 of a thief hatch 102 on an oil tank 104 situated in an oil field. The thief hatch 102 allows an oil worker to access the inside of the oil tank 104. The thief hatch 102 can be used as a means for lowering a rod or stick into the oil tank 104 to gauge the depth of the oil or other liquid inside. The thief hatch 102 also has other uses and allows an operator to see inside the tanks for various reasons.

If the thief hatch 102 is left open, vapors can escape from the oil tank 104. These vapors may be harmful to the environment so it is desirable to keep the thief hatch 102 closed as much as possible. Additionally, the vapors may be explosive, so an open hatch presents a potential explosion hazard.

It is important to known when the thief hatch 102 is open to be able to verify that it is open for a legitimate purpose and to take necessary action if the thief hatch 102 is open for an illegitimate purpose. It is also important to make sure a thief hatch 102 is properly closed after legitimate uses. It is also advantageous if the information regarding the state of the thief hatch, for example thief hatch being opened or closed, or improperly closed, can be sent to a remote location. There are many advantages to using remote monitoring of the state of the thief hatch 102. Remote monitoring can greatly reduce the burden on field operations personnel.

Known sensors for a thief hatch 102 are proximity sensors. These proximity sensors are state sensors that monitor the state of the thief hatch 102 as open or closed. These proximity sensors often use a magnet that is attached to one part of the thief hatch 102 and a sensor that is attached to a second part of the thief-hatch 102. For example, the magnet can be attached to the oil tank 104, and the sensor can be attached directly to the thief hatch 102. In various designs, the sensor can be a reed relay, Hall-effect sensor, or numerous other type of magnetic sensor. When the magnet is in close proximity to the sensor, where there is strong magnetic communications, the thief hatch 102 is considered to be closed. When the magnet is not in close proximity to the sensor, where there is weak or no significant magnetic communication, the thief hatch 102 is considered to be open. One significant problem with these known thief hatch proximity sensor systems is that they include two parts, the sensor and the magnet. It is also a problem that both parts need to be physically mounted. Another significant problem is that the sensor needs to be carefully aligned with the magnet to be able to properly indicate when the thief hatch 102 is open and closed. Thus, with prior art systems, two parts must be mounted, and these parts must be sized, shaped and placed to be able work for each particular hatch type.

One aspect of the present teaching is to provide a much simpler and faster way to install and calibrate a thief hatch state sensor system. A sensor is housed in a module that is attached to the thief hatch 102. In various embodiments, the sensor comprises a sensor that measures angular position. In some embodiments, the sensor measures angular position in one axis. In some embodiments, the sensor measures angular position in two axes. In some embodiments, the sensor measures angular position in three axes. In one embodiment of the present teaching, the sensor comprises an accelerometer housed in a module attached to the thief hatch 102. The accelerometer is used to detect a change in the attitude, or angular position, of the thief hatch 102. In some embodiments, the accelerometer is a three-axis accelerometer. However, in some other embodiments, fewer axes are used. In some embodiments of the present teaching, the sensor comprises an electrolytic tilt or other types of sensors that measure position in space with respect to the earth's gravitational field.

A processor, such a microprocessor, or other processor system, determines the state of the thief hatch based on the angular position information provided by the sensor. Specifically, in some embodiments, the processor determines, based on the signal provided by the sensor, when the angular position of the thief hatch changes by more than a predetermined amount. The processor then sends a signal indicating the state of the thief hatch 102 to a remote user or remote processing and/or communication network.

One feature of the thief hatch monitor system of the present teaching is that the process for installation and operation is relatively simple. A module that includes the accelerometer is attached to the thief hatch 102. The module is powered to the “ON” state. The thief hatch 102 is placed in a closed state with the latch down. A switch is actuated that sets a “ZERO” state of the sensor. In some embodiments, a user activates the switch to set a “ZERO” state of the sensor. The “ZERO” state of the sensor represents a “CLOSED” state of the thief hatch 102. This “ZERO” state information may be provided to a user that may be a local or remote user. In some embodiments, any deviation from this “ZERO” position would result in an “OPEN” thief-hatch state indication. An “OPEN” thief-hatch state indication is provided to a user, which may be a local or remote user. In some embodiments, the state information of the sensor is sent to a gateway device that provides an end-user remote access to the state information of the thief hatch.

Thus, the thief hatch monitor system of the present teaching uses an angular measurement to determine whether the thief hatch is fully closed or in some state of openness. One feature of the thief hatch monitor system of the present teaching is that there is essentially no calibration or setup. Another feature of the thief hatch monitor system of the present teaching is it works with virtually any type of thief hatch. The thief hatch monitor system of the present teaching only needs to be simply attached without significant alignment and to be zeroed in order to begin operation.

In various embodiments, the processor determines a variety of states of the thief hatch based on the signal provided by a sensor relating to angular position. The processor uses data from a sensor capable of giving change in attitude measurements, and then the processor uses algorithms to determine the state relative to the zero-state set by a user. In some embodiments, the change in angular position data provided by the sensor is compared to a predetermined value of angular position stored in the processor to establish a particular state of the thief hatch. In some embodiments, one predetermined angular position indicates an open state. In various embodiments, the state or states determined by the processor may include one or more of an open state, a cracked-open state, a closed state, and an over-closed state. For example, an open state may represent a large predetermined positive angular position, a cracked-open state represents a smaller predetermined positive angular position, a closed state represents a substantially zero predetermined angular position, and an over-closed state represents a negative predetermined angular position data provided by the sensor.

One feature of the thief hatch sensor system of the present teaching is that the installation process does not require any alignment because the thief hatch sensor is a single unit. The sensor unit can be mounted on the hatch in any orientation and then zeroed. There is no need to mount two components, such as a magnet and sensor, as with known thief hatch proximity sensors. In addition, there is no need for calibration as in the prior art thief hatch sensors.

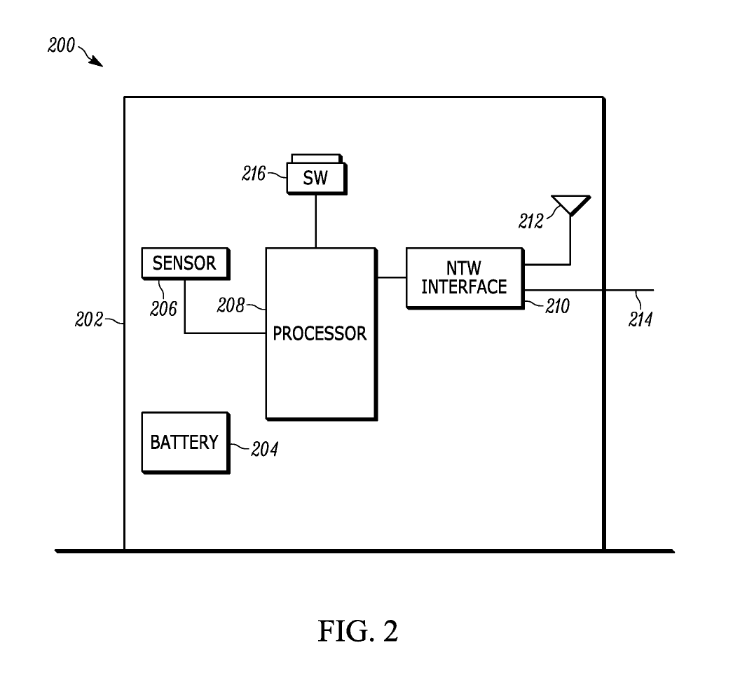

FIG. 2 illustrates an embodiment of a thief hatch state sensor module 200 of the present teaching. The thief hatch state sensor module 200 of the present teaching comprises an enclosure 202. The enclosure 202 protects the sensor apparatus from the elements, and allows for simple mounting to the thief hatch. In some embodiments, the enclosure 202 is designed to meet standards of the National Electrical Manufacturers Association (NEMA) of 4× or better. In some embodiments, the enclosure 202 is watertight, excluding at least 65 GPM of water from a 1-inch nozzle delivered from ten feet or more distance for five minutes. Also, in some embodiments, the enclosure 202 is corrosion resistant. Also, in some embodiments, the enclosure 202 is configured in a shape that can be easily attached to a bracket for mounting to different types of thief hatches. In various applications, the enclosure 202 can be bonded to the thief hatch by welding or other bonding means.

The thief hatch state sensor module 200 includes a battery 204 or other type of power source. In some embodiments the battery 204 is chosen and sized to provide a five-year minimum life to reduce maintenance. In some embodiments, the battery is a lithium battery. In various embodiments, the battery provides power to one or more of the state sensor, the processor, and a telemetry processor.

The thief hatch state sensor module 200 includes a sensor 206 that measures angular position. The sensor 206 can be either an analog or a digital device that generates an analog or a digital signal at an output. The digital or analog output of the sensor 206 is electrically connected to an input of a processor 208. For embodiments that include analog sensors 206, an analog-to-digital converter may be used. The analog-to-digital converter is connected to the output of the sensor to covert the analog acceleration data to digital acceleration data. The output of the analog-to-digital converter may then be connected to the processor 208 and provide a digital conversion of the analog sensor data. In some embodiments, the processor 208 is a microprocessor. In other embodiments, the processor 208 comprises electrical components, such as switches and relays. The processor 208 includes an output that is connected to a network interface 210 that is labeled NTW INTERFACE in the drawing. In some embodiments, the processor 208 provides a transistor output. In some embodiments, the network interface 210 is a wired interface that connects the transistor output to devices outside the enclosure 202. In some embodiments, the network interface 210 can be a wireless interface that includes an antenna 212, or a wired interface that connects to a network cable 214.

One feature of the present teaching is that in various embodiments, the module 200 provides different forms of data to the user. For example, in some embodiments, analog data representing angular position of the thief hatch from the sensor is sent directly from the module 200. In some embodiments, digital data representing angular position of the thief hatch from an output of a digital sensor, or from an output of an analog sensor that is connected to an analog-to-digital converter, is sent directly from the module 200. In some embodiments, a state of the thief hatch, as determined by a processor 208 based on the sensor data, is sent from the module 200.

In some embodiments, the sensor 206 is a three-axis angular sensor 206 that provides angular position information in three-dimensions. In other embodiments, the sensor 206 measure single-axis or a dual-axis angular position. In various embodiments, the processor 208 is a microprocessor that implements one of numerous algorithms to compute or estimate the angular position of the thief hatch based on data from the sensor 206. These algorithms can use sensor data from a single axis, double axis, or three-dimensional sensor 206.

In some embodiments, the sensor 206 comprises an accelerometer that measures the acceleration of the thief hatch. The accelerometer of the present teaching can use any of, or a combination of, a variety of accelerometer technologies. The accelerometer may provide acceleration data along a single axis, double axis, or in three-dimensions. Thus, some embodiments of the accelerometer of the present teaching utilize a three-axis accelerometer to provide acceleration information in three-dimensions to determine angular position in three dimensions. Other embodiments of the accelerometer of the present teaching use a single-axis or a dual-axis accelerometer. In various embodiments, the processor 208 is a microprocessor that implements one of numerous algorithms to compute or estimate the angular position of the thief hatch from accelerometer data. These algorithms can use acceleration data from a single axis, double axis, or three-dimensional accelerometer.

The network interface 210 is electrically coupled to the processor 208. The network interface 210 transmits the information from the processor 208 to a communications gateway device. In many embodiments, a switch 216 is electrically connected to the processor 208. In some embodiments, a switch 216 is accessible and may be actuated from outside the enclosure 202.

In some methods of operation, the processor 208 reads the output data of the sensor 206 and determines the attitude of the sensor 206 based on the output data. In some methods of operation, a positive value of the attitude indicates the position of the hatch is open. Also, in some methods of operation, the processor 208 determines whether the angular position of the hatch exceeds a predetermined value based on the processed data from the accelerometer. If the angular position of the hatch does exceed the predetermined value, the processor 208 transmits a signal that indicates the hatch is in an “OPEN” state. In some embodiments, if the angular position of the hatch does not exceed a predetermined positive value, the processor 208 transmits a signal that indicates the hatch is in a “CLOSED” state. In some embodiments, if the angular position of the hatch exceeds a predetermined positive value, the processor 208 transmits a signal that indicates the state of the hatch is “CRACKED-OPEN.” In some embodiments, if the angular position of the hatch exceeds a predetermined negative value, the processor 208 transmits a signal that indicates the state of the hatch is “OVER-CLOSED.”

In operation, when a switch 216 is activated, the thief hatch state sensor 200 is set to a “ZERO” state. When the thief hatch position is changed, the sensor 206 senses a change in attitude, and provides a signal to the processor 208. The processor 208 determines whether the magnitude of the change is outside a preconfigured value. If the magnitude of the change is outside a preconfigured value, the processor 208 sends a signal to the network interface 210 that indicates that the thief hatch is in an “OPEN” state. The network interface 210 sends a signal using a wired and/or wireless connection to a gateway device for access by an end user.

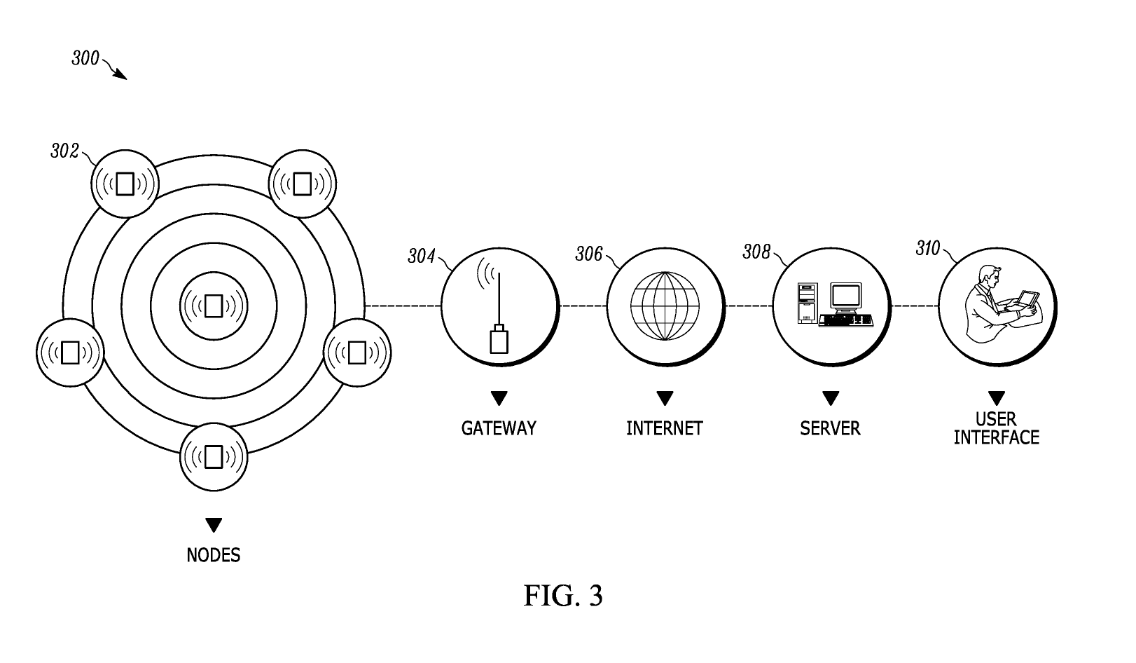

One feature of the thief hatch state sensor of the present teaching is that it can be deployed in a large monitoring system that provides remote sensing of multiple tanks in a field deployment of tanks. FIG. 3 illustrates an embodiment of a remote thief hatch monitoring system 300 of the present teaching that can be used for remote tank sensing applications with one or more industrial tanks. The nodes 302 of the remote thief hatch monitoring system 300 comprise various forms of sensors and telemetry devices that are wirelessly connected. In some embodiments, each node 302 of the remote thief hatch monitoring system 300 comprises a thief hatch state sensor module similar to the thief hatch state sensor module 200 that is shown in FIG. 2. In some embodiments, only some of the nodes comprise thief hatch state sensor modules similar to the thief hatch state sensor module 200. Data is provided by the sensors and/or processors associated with the nodes 302 and this data is transmitted to the gateway device 304 by the network interface 210 using the most direct path. The data may be automatically repeated by other nodes 302 if necessary. In the embodiment illustrated of FIG. 3, the data is transmitted via a wireless network. In other embodiments, the network is a wired network. In still other embodiments, the network is a network comprising both wired and wireless network interfaces.

The nodes 302 send and receive information to and from a gateway device 304 that includes a receiver and a transmitter that receive and transmit the information from the nodes 302. The gateway device 304 includes a data interface. In some embodiments, the data interface is a standard supervisory control and data acquisition (SCADA) system. In some embodiments, the data interface is a programmable logic controller (PLC). Additionally, the gateway device 304 may include two digital outputs that are configured to be active if one or more thief hatches are open for a time that is in excess of a predetermined period of time. In some embodiments, the gateway device includes analog ports that receive analog data from the sensor and transmit analog data to the user.

One feature of the remote thief hatch monitoring system of the present teaching is that it allows the integration of all types of sensors and actuators into a single network. This way, the best sensor types and sensor locations for each application can be deployed. The wireless communication system enables communications with all devices. For example, the gateway device 304 can accommodate on order of 10,000 transceiver nodes 302. A network using the methods and apparatus of the present teaching can cover a geographic range of hundreds of square miles. In some embodiments, some nodes 302 act as data relay devices for connecting other nodes 302 to the gateway device 304. The gateway device 304 can be connected to the Internet 306 and/or to one or more back-end servers 308. The gateway device 304 can also be connected to a private secure network.

The gateway device 304 sends data to a user interface 310. The user interface 310 may be provided on a personal computer or numerous other types of processing and/or end-user devices. The user interface 310 allows both data readout from the sensors as well as remote configuration of the sensor devices. The data can be provided using the industry-standard Modbus RTU protocol for monitoring and control.

In some embodiments, the nodes 302 can automatically install themselves and their associated registers. In some embodiments, each node 302 has a unique Modubus slave ID, and the most recent node data is stored in the gateway device 304 until it is polled by the PLC or the remote terminal unit (RTU) in a SCADA system. In some embodiments, the nodes 302 that are offline “time out” to alert the system controller or user connected to the user interface 310 when there is a problem.

In some embodiments, the gateway device 304 mounts on a DIN rail. In these embodiments, the gateway device 304 is an integrated device combining a high power radio with the gateway electronics in a single DIN mounted package. The gateway device 304 includes two configurable digital outputs that may be used for local alarming and control. The gateway device 304 includes a configuration and debugging interface or port that can be an RS-232 port. The gateway device 304 includes an antenna port for connecting to an RF antenna that may be a RP-SMA Antenna port for connection to 900 MHz antennas. In some embodiments, the gateway device 304 includes two digital outputs for local signaling or alarming, and internal logic to map any remote data to these outputs. In some embodiments, the gateway device 304 includes a communication connection port that may be an Ethernet connection port. The Ethernet connection port may provide a TCP connection to the Internet and/or connect to backend server devices. In some embodiments the gateway device 304 includes an analog output. In some embodiments, the gateway device 304 stores the most recent readings of all nodes 302 in the network in Modbus format. The gateway device 304 supports remote node configuration.

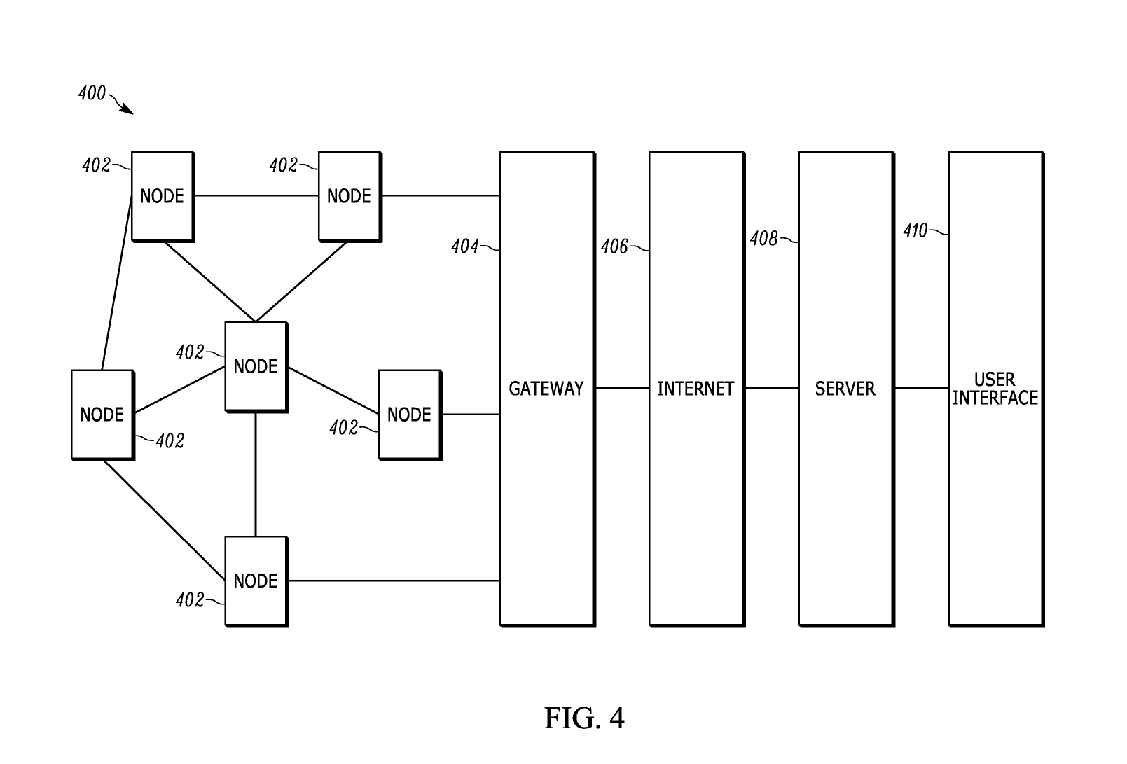

FIG. 4 illustrates an embodiment of a remote thief hatch monitoring system 400 connected in a wired network of the present teaching. Nodes 402 of a remote thief hatch monitoring system 400 comprise various forms of sensors and telemetry devices that are connected to a network cable. In some embodiments, each node 402 of the remote thief hatch monitoring system 400 comprises a thief hatch state sensor module similar to the thief hatch state sensor module 200 that is shown and described in connection with FIG. 2. In some embodiments, only some of the nodes 402 comprise thief hatch state sensor modules similar to the thief hatch state sensor module 200. Data indicating the state of the thief hatch is provided by the sensors and processors associated with the nodes 402 and this data is transmitted to the gateway device 404 by the network interface 210 using the most direct path. The nodes 402 send and receive information to and from a gateway device 404. The gateway device 404 includes a data interface. The gateway device 404 can be connected to the Internet 406 and/or to one or more back-end servers 408. The gateway device 404 can also be connected to a private secure network. The gateway device 404 brings user data to a user interface 410. The user interface 410 allows both data readout from the sensors as well as remote configuration of the sensor and processor devices in the sensor module 200.

The connection configuration of nodes 402 in the remote thief hatch monitoring system 400 can be any known network configuration including, for example, ring, bus, or star. In some embodiments, some nodes 402 act as data relay devices for connecting other nodes 402 to the gateway device 404. These nodes 402 may automatically repeat the transmit signal indicating the state of the thief hatch generated by the network interface 210 of another thief hatch state sensor module 200 in a different node 402.

In some methods of operation, the remote thief hatch monitoring system of the present teaching sends data to a remote digital node. Data may be written to a Modbus register/coil. Commands may be transmitted to sensor devices. Write confirmation information is also relayed through the system.

### Equivalents

While the Applicant's teaching is described in conjunction with various embodiments, it is not intended that the Applicant's teaching be limited to such embodiments. On the contrary, the Applicant's teaching encompass various alternatives, modifications, and equivalents, as will be appreciated by those of skill in the art, which may be made therein without departing from the spirit and scope of the teaching.

What is claimed is:

1. A thief hatch state monitoring system comprising:
a) a thief hatch sensor that detects a change in angular position of a thief hatch and generates sensor data at an output in response to the detected change;
b) a processor having an electrical input that is electrically connected to the output of the thief hatch sensor, the processor determining when an angular position of the thief hatch changes by more than a predetermined amount from the sensor data and then generating a signal at an output indicating a state of the thief hatch;
c) a network interface that is electrically connected to the output of the processor, the network interface generating a transmit signal indicating the state of the thief hatch based on the signal generated by the processor; and
d) a communication gateway comprising a receiver that receives the transmit signal indicating the state of the thief hatch, the communication gateway being electrically connected to an end-user and providing the end-user access to the state of the thief hatch.

2. The thief hatch state monitoring system of claim 1 wherein the thief hatch sensor detects a change in angular position in one axis.

3. The thief hatch state monitoring system of claim 1 wherein the thief hatch sensor detects a change in angular position in two axes.

4. The thief hatch state monitoring system of claim 1 wherein the thief hatch sensor detects a change in angular position in three axes.

5. The thief hatch state monitoring system of claim 1 wherein the thief hatch sensor comprises an accelerometer.

6. The thief hatch state monitoring system of claim 1 wherein the thief hatch sensor comprises an electrolytic tilt sensor.

7. The thief hatch state monitoring system of claim 1 wherein the thief hatch sensor comprises a digital sensor.

8. The thief hatch state monitoring system of claim 1 wherein the network interface comprises a wireless interface.

9. The thief hatch state monitoring system of claim 1 wherein the network interface comprises a wired interface.

10. The thief hatch state monitoring system of claim 1 wherein the communication gateway comprises a data interface having a supervisory control and data acquisition (SCADA) system.

11. The thief hatch state monitoring system of claim 1 wherein the communication gateway comprises a data interface having a programmable logic controller.

12. The thief hatch state monitoring system of claim 1 wherein the communication gateway device comprises a debugging interface.

13. The thief hatch state monitoring system of claim 1 wherein the communication gateway device comprises an analog port.

14. The thief hatch state monitoring system of claim 1 further comprising a user operated switch that is electrically connected to the processor.

15. The thief hatch state monitoring system of claim 1 further comprising a battery that powers at least one of the thief hatch state sensor, processor, and network interface.

16. The thief hatch state monitoring system of claim 1 wherein the communication gateway is connected to the Internet.

17. The thief hatch state monitoring system of claim 1 further comprising a server electrically connected to the communication gateway.

18. A remote thief hatch state monitoring system comprising:
a) a plurality of thief hatch sensor modules, each of the plurality of thief hatch modules comprising:
i. a thief hatch sensor that detects a change in angular position of a thief hatch and that generates sensor data at an output in response to the detected change;
ii. a processor having an electrical input that is electrically connected to the output of the thief hatch sensor, the processor determining when an angular position of the thief hatch changes by more than a predetermined amount from the sensor data and then generating a signal at an output indicating a state of the thief hatch; and
iii. a network interface that is electrically connected to the output of the processor, the network interface generating a transmit signal indicating the state of the thief hatch based on the signal generated by the processor; and
b) a communication gateway comprising a receiver connected to an output of the network interface, the communication gateway receiving transmit signals from each of the plurality of thief hatch sensor modules indicating the states of the plurality of thief hatches, the communication gateway being electrically connected to a network that provides an end-user remote access to at least one of the plurality of generated transmit signals indicating the states of the plurality of thief hatches.

19. The remote thief hatch monitoring system of claim 18 further comprising a node that is wirelessly connected to at least one of the plurality of thief hatch modules, the node automatically repeating a corresponding transmit signal indicating the state of the corresponding thief hatch.

20. The remote thief hatch monitoring system of claim 18 wherein at least some of the plurality of thief hatch modules are wirelessly connected to at least some other of the plurality of thief hatch modules.

21. The remote thief hatch monitoring system of claim 18 wherein the network is the Internet.

22. The remote thief hatch monitoring system of claim 18 wherein the network is a private network.

23. The thief hatch state monitoring system of claim 18 wherein the communication gateway comprises a data interface having a supervisory control and data acquisition (SCADA) system.

24. The thief hatch state monitoring system of claim 18 wherein the communication gateway comprises a data interface having a programmable logic controller.

25. The thief hatch state monitoring system of claim 18 wherein the communication gateway device comprises a debugging interface.

26. A method of remote thief hatch state monitoring, the method comprising:
a) attaching a thief hatch sensor that detects a change in angular position to a thief hatch;
b) sensing a change in an angular position of the thief hatch using the attached thief hatch sensor and generating sensor data in response to the change;
c) determining if the angular position of the thief hatch changes by more than a predetermined amount based on the generated sensor data and generating a signal indicating a state of the thief hatch based on the determination that the angular position of the thief hatch changes by more than the predetermined amount;
d) generating a transmit signal indicating the state of the thief hatch; and
e) receiving the transmit signal indicating the state of the thief hatch and providing access to the state of the thief hatch to an end-user.

27. The method of remote thief hatch state monitoring of claim 26 further comprising generating a “ZERO” state of the attached thief hatch sensor.

28. The method of remote thief hatch state monitoring of claim 26 wherein the sensing the change in the angular position of the thief hatch using the attached thief hatch sensor comprises measuring an acceleration of the thief hatch.

29. The method of remote thief hatch state monitoring of claim 26 wherein the sensing the change in the angular position of the thief hatch using the attached thief hatch sensor comprises measuring a tilt of the thief hatch.

30. The method of remote thief hatch state monitoring of claim 26 wherein the generating the transmit signal indicating the state of the thief hatch comprises generating a signal indicating an “OPEN” state based on a determination that the angular position of the thief hatch changes by more than a predetermined positive amount.

31. The method of remote thief hatch state monitoring of claim 26 wherein the generating the transmit signal indicating the state of the thief hatch comprises generating a signal indicating an “OVER-CLOSED” state based on a determination that the angular position of the thief hatch changes by more than a predetermined negative amount.
